(19) United States
(12) Patent Application Publication
(10) Pub. No.: US 2015/0205381 A1
(43) Pub. Date: Jul. 23, 2015

(54) MOBILE GAMING CONTROLLER WITH INTEGRATED VIRTUAL MOUSE

(71) Applicant: NVIDIA Corporation, Santa Clara, CA (US)

(72) Inventors: David Lee Eng, San Jose, CA (US); Ilkka Varje, Kirkkonummi (FI); Kevin Bruckert, Pflugerville, TX (US); Richard J. Seis, Sunnyvale, CA (US); Andrija Bosnjakovic, Santa Clara, CA (US); Aleksandar Odorovic, Santa Clara, CA (US)

(73) Assignee: NVIDIA Corporation, Santa Clara, CA (US)

(21) Appl. No.: 14/158,579

(22) Filed: Jan. 17, 2014

(51) Int. Cl. G06F 3/038; A63F 13/23; G06F 3/0488

(52) U.S. Cl. CPC G06F 3/0383; G06F 3/0488; A63F 13/23; A63F 2300/1031

(57) ABSTRACT

A method is enacted in a computer system operatively coupled to a hand-actuated input device. The method includes the action of determining automatically which form of user input to offer a process running on the computer system, the user input including position data from the input device. The method also includes the action of offering the position data to the process in the form determined.

### BACKGROUND

In mobile computer systems such as tablets, smartphones, and portable game systems, a touch-screen display may serve as the primary user-input mechanism. With some applications, however, the required user input is more easily furnished via a handheld game controller having one or more joysticks, triggers, and pushbuttons. Accordingly, some mobile computer systems are configured to pair with an external game controller to accept user input therefrom, especially when running video-game applications. A disadvantage of this approach becomes evident, however, when the user leaves the video-game application and attempts to access other user-interface (UI) elements—e.g., elements configured primarily for touch input. The user then must choose from among equally undesirable options: clumsily navigating the UI elements with the game controller, taking a hand off the controller to manipulate the touch-screen display, or similarly interrupting the user experience by using a mouse or other pointing device, which often has to be manually paired with the computer system.

### BRIEF DESCRIPTION OF THE DRAWINGS

The inventors herein have recognized the disadvantages noted above and now disclose series of approaches to address them. This disclosure will be better understood from reading the following Detailed Description with reference to the attached drawing figures, wherein:

FIGS. 1 and 2 show aspects of an example game system in accordance with an embodiment of the disclosure; and

FIG. 3 illustrates an example method to provide user input to a process, in accordance with an embodiment of the disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

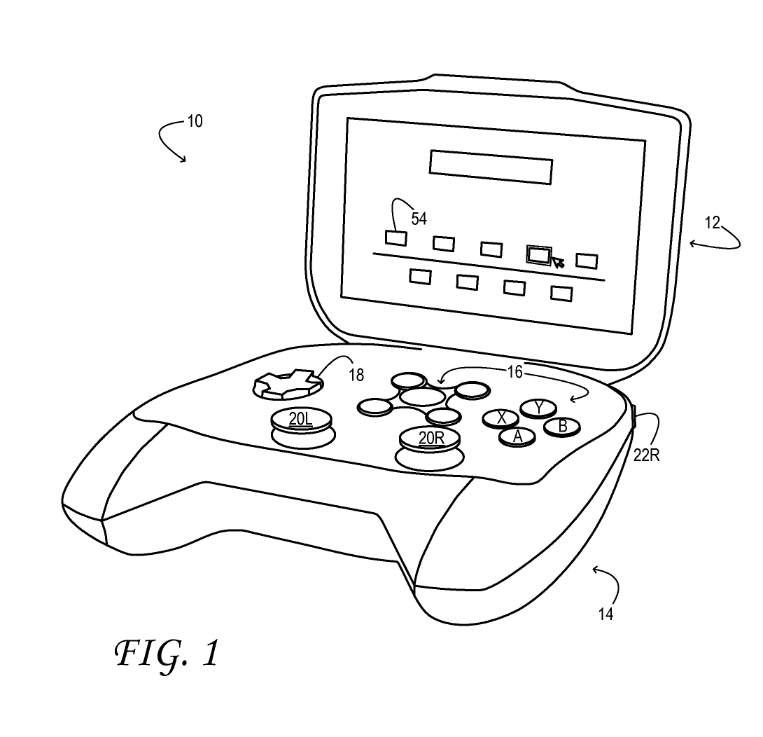

FIG. 1 shows aspects of an example handheld game system 10. The game system includes a touch-screen display 12 pivotally connected to a game controller 14. The game controller includes several controls: pushbuttons 16, a direction pad 18, left and right joysticks 20L and 20R, and left and right triggers 22L (not shown) and 22R. The game controller is configured to be held in both hands by the game-system user, with the left and right joysticks within reach of the user's thumbs.

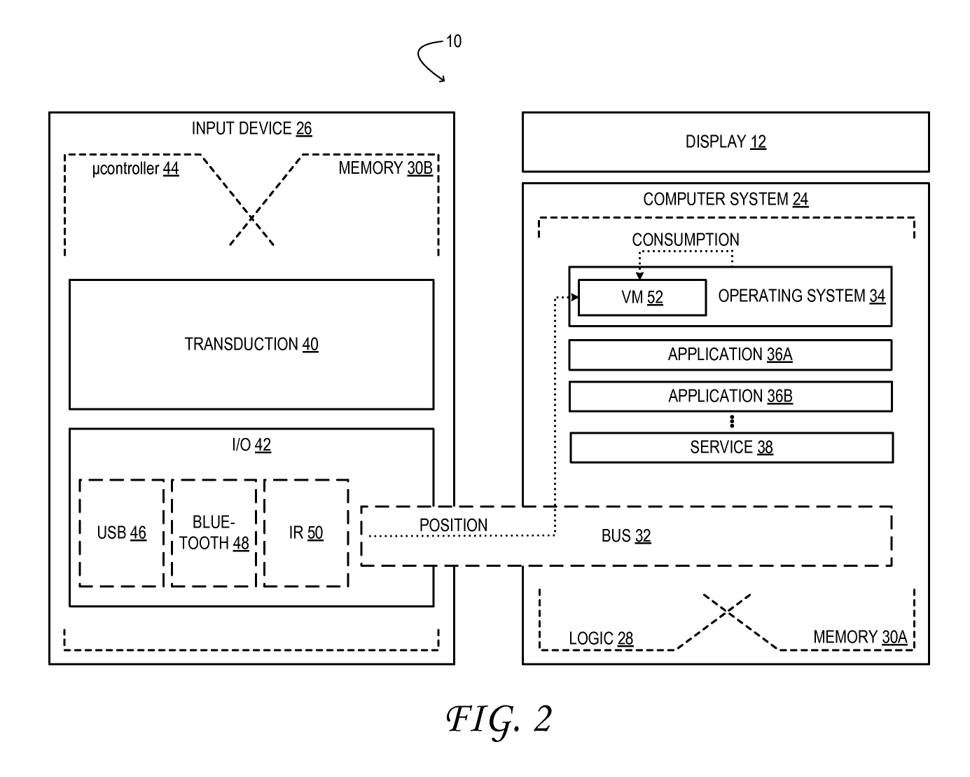

FIG. 2 shows additional aspects of game system 10 in one embodiment. This high-level schematic diagram depicts various functional components of the game system, which include computer system 24 and input device 26, in addition to touch-screen display 12. The computer system includes logic subsystem 28 and memory subsystem 30A. The logic subsystem may include one or more central processing units (CPUs), graphics processing units (GPUs), and memory controllers (not shown in the drawings). Each CPU and GPU may include inter alio a plurality of processing cores. Memory subsystem 30A may include volatile and non-volatile memory for storing code and data. The memory subsystem may conform to a typical hierarchy of static and/or dynamic random-access memory (RAM), read-only memory (ROM), magnetic, and/or optical storage. Internal bus 32 enables code and data to flow between the memory and logic subsystems.

Operating together, memory subsystem 30A and logic subsystem 28 instantiate various software constructs in computer system 24—an operating system (OS) 34, and applications 36A, 36B, etc. The OS may include a kernel, such as a Linux® kernel, in addition to drivers and a framework. In some embodiments, the memory and logic subsystems may also instantiate one or more services 38, and any data structure useful for the operation of the computer system.

Input device 26 is configured to transduce the user's hand movements into data and to provide such data to computer system 24 as user input. To this end, the input device includes transduction componentry 40 and input-output (I/O) componentry 42. To support the functions of the transduction and I/O componentry, the input device may include a dedicated microcontroller 44 and at least some memory 30B operatively coupled to the microcontroller.

Transduction componentry 40 is configured to transduce one or more hand movements of the user into position data. Naturally, such hand movements may include movements of the user's fingers or thumbs, which may be positioned on the various controls of the input device 26. The nature of the transduction componentry and associated controls may differ in the different embodiments of this disclosure. In the embodiment shown in FIG. 1, for example, the transduction componentry includes pushbuttons 16, direction pad 18, left and right joysticks 20L and 20R, and left and right triggers 22L and 22R. Such componentry may be at least partly electromechanical. Pushbuttons, where present, may be linked to electromechanical switches, and joysticks may be linked to dual-axis potentiometers and/or electromagnetic switches. When the user presses the joystick from above, for instance, it may function as a pushbutton. These electromechanical components may be coupled to suitable addressing circuitry to determine the state of each pushbutton (e.g., open or closed), to convert the variable resistance of a potentiometer into digital data, etc. In other embodiments, the transduction componentry may include a trackball control and associated addressing componentry to count the number of revolutions (or fractions thereof) that the trackball has made along each of a pair of orthogonal axes. In some embodiments, input device 26 may be integrated together with computer system 24, as in game system 10 of FIG. 1. In other embodiments, the input device may be physically separate from the computer system and may communicate with the computer system via suitable I/O componentry (vide infra).

I/O componentry 42 is configured to take the position data furnished by transduction componentry 40 and convey the position data to computer system 24, where it is offered to one or more processes running on the computer system. Such processes may include a process of OS 34, of any of the applications 36, or of service 38, for example. The nature of the I/O componentry may differ from one embodiment to the next. As shown in FIG. 2, suitable I/O componentry may include a USB interface 46, a Bluetooth transmitter 48, and/or an IR transmitter 50. In other embodiments, the I/O componentry may include a near-field transmitter. In still other embodiments, the computer system and the input device may communicate directly via internal bus 32. This type of interface may be used, for example, when input device 26 is integrated together with computer system 24, as in the embodiment of FIG. 1. As described in further detail below, I/O componentry 42 may be configured to offer more than one form of position data, irrespective of the I/O variant in use.

It will be understood that user input may be provided to computer system 24 from other componentry besides input device 26. In embodiments where display 12 is a touch-screen display, for instance, touch input may be received from the touch-screen display. In some scenarios, the touch-screen display may be further configured to present a virtual keyboard or keypad in some user contexts. In these and other embodiments, game system 10 may include one or more cameras or microphones to provide input.

In the embodiment of FIG. 2, a virtualization module 52 resides within OS 34 of computer system 24. The virtualization module is configured to determine automatically—i.e., without any intentional action by the user—which form or forms of user input from input device 26 will be offered to a given process running on the computer system. Pursuant to the automatic determination made by the virtualization module, the position data transduced by the input device is passed through, converted, or virtualized into the desired form. In some embodiments, such conversion or virtualization may be enacted in the virtualization module itself. Accordingly, the virtualization module may provide a layer of abstraction between the input device and the process receiving the position data. In other embodiments, at least some of the required conversion or virtualization may be enacted in transduction componentry 40 of the input device, pursuant to directives from the virtualization module. In still other embodiments, the virtualization module itself may be a component of the input device—i.e., embodied in software resident in memory subsystem 30B and executed by microcontroller 44. Here, the virtualization module may be configured to interrogate the computer system, or to receive feedback from the computer system, as needed to determine which form of user input is to be offered a given process.

In a typical use scenario, transduction componentry 40 of input device 26 transduces the user's hand movement—e.g., the movement of the user's right thumb on right joystick 20R. Useful data of at least two forms can be derived from the transduction. These include:

(a) absolute position data typical of a joystick control, and

(b) relative position data typical of a pointing device (e.g., mouse, trackball, trackpad, or similar control).

Virtualization module 52 may be configured to select the appropriate form for consumption by any process running on computer system 24. More particularly, the user's hand position may be reported as joystick control data in a first mode of operation, and as virtualized mouse data in a second mode of operation. To this end, transduction componentry 40 may include an analog-to-digital converter configured to convert the dual potentiometric output of a joystick control into a pair of digital signals proportionate to the X and Y coordinates of the joystick. The virtualization module may include differentiating logic which computes the derivative of the X and Y coordinates with respect to time or some other process variable. Subject to further processing, such as noise-reduction processing, the derivatives of the X and Y coordinates may be used in the virtualization module to compute ΔX and ΔY values, which are offered to the operating system as virtual-mouse data. In one embodiment, the differentiating logic acts on X and Y data from the right joystick of the input device. In other embodiments, data from the left joystick or both the left and right joysticks may be used.

The inventors herein have explored various mechanisms in which the user of a game system is tasked with intentionally selecting the mode in which to operate an input device—i.e., to provide virtual mouse or joystick input data per user request. In one example scenario, a user playing a video game may operate the right joystick as a joystick to move a character in a video game or reorient the field of view of the character. At some point, however, the user may receive a text message or email alert, or for any other reason decide to switch out of the game to access the home screen of the game system. The home screen—turning back to FIG. 1—may show various icons or other UI elements 54 that the user may navigate among and select in order to launch other applications—e.g., to read email. For this type of navigation, a virtual mouse with a mouse pointer may be an appropriate tool, and the user may be required to flip a switch on the input device (which may require the user to un-pair and then re-pair the input device to the computer system), speak a command, or take some other deliberate, extraneous action to make the input device offer virtual-mouse input to the computer system, instead of the joystick input previously offered. Then, when the user decides to return to the game, this action would have to be reversed. Although a plausible option, this approach may lead to an unsatisfactory user experience by requiring the user to ‘step out’ of the current navigation context to change the operating mode of the input device.

Another option, which provides a more fluid user experience, is to enable virtualization module 52 to monitor conditions within the computer system 24, and based on such conditions, determine the form in which to offer position data to an executing process. In the more particular approach outlined hereinafter, the conditions assessed by the virtualization module may include knowledge of which application has input focus, whether that application is consuming user input as offered by the input device, whether the offering of such input triggers an error, and whether other user-input conditions are detected that heuristically could indicate that the user desires to transition from one form of input to another.

No aspect of the foregoing drawings or description should be understood in a limiting sense, for numerous other embodiments lie within the spirit and scope of this disclosure. For instance, although FIG. 1 shows a handheld game controller with an integrated computer system and display, this disclosure is equally applicable to controllers for stationary game systems, and to multifunction computer systems not dedicated to gaming per se. Such multifunction computer systems may include desktop computers, laptop computers, tablet computers, and smartphones. Although the controller, computer, and display components are fully integrated in the embodiment of FIG. 1, these components may be separate in other embodiments, or any two may be integrated together. Furthermore, the basic function of display 12 in the embodiments shown above may be incorporated into a wearable near-eye display.

The configurations described above enable various methods to provide user input to a computer system. Accordingly, some such methods are now described, by way of example, with continued reference to the above configurations. It will be understood, however, that the methods here described, and others fully within the scope of this disclosure, may be enabled by other configurations as well. Naturally, each execution of a method may change the entry conditions for a subsequent execution and thereby invoke a complex decision-making logic. Such logic is fully contemplated in this disclosure. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

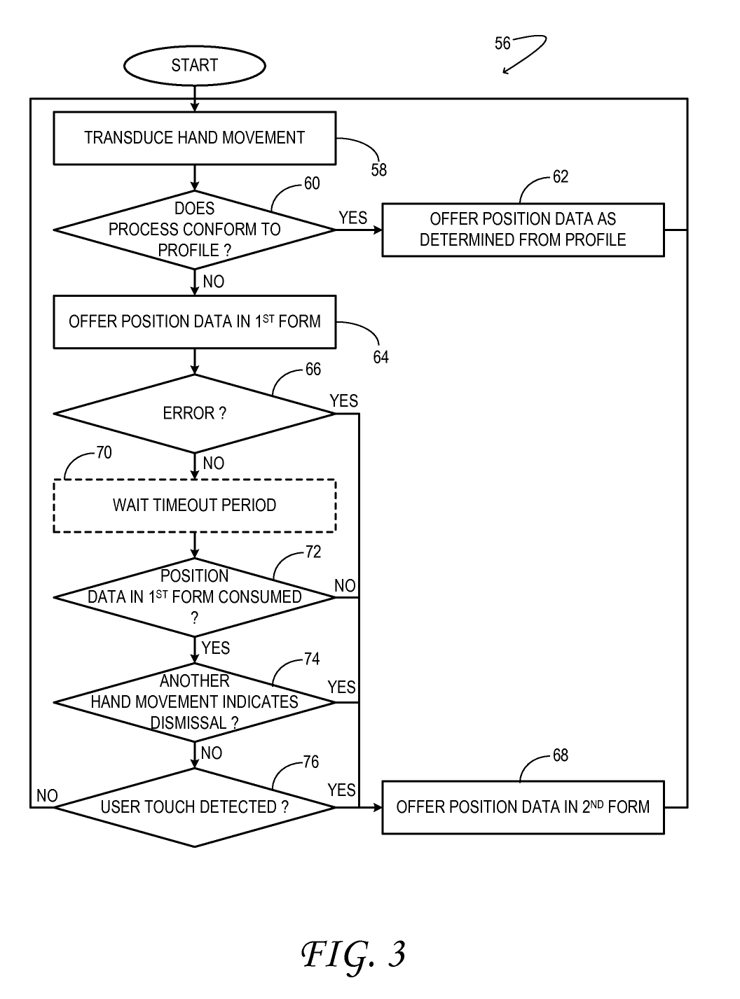

FIG. 3 illustrates an example method 56 to be enacted in a computer system operatively coupled to a hand-actuated input device. The illustrated method provides user input to the computer system. At 58 of method 56, transduction componentry of the input device transduces a hand movement of a user of the computer system into position data. In this and other embodiments, subsequent method steps automatically determine the form in which the position data derived from the transduced hand movement is to be offered as user input to the one or more processes running on the computer system. Such actions may include selecting a first form of user input and rejecting a second form of user input from a plurality of forms that the virtualization module or transduction componentry is capable of offering.

An example first form of user input may include joystick input, where absolute position coordinates—e.g., Cartesian coordinates X and Y or polar coordinates R and θ—specify position. An example second form of user input is virtual-mouse input, where relative position coordinates—e.g., ΔX, ΔY—specify a change in position over a predetermined interval of time or other process parameter. In some embodiments, the absolute and relative coordinates may be specified programmatically using different data structures: a game-controller data structure for the absolute position data, and a virtual-mouse, trackball, or trackpad data structure for the relative position data. Advantageously, the determinations of method 56 may be made without intentional user action—e.g., without plugging in another device, un-pairing and re-pairing input devices, or flipping a switch to indicate the form of input to be offered.

In multi-tasking environments, numerous processes may run concurrently. While the illustrated method may apply to any such process or processes, it offers particular utility when applied to the so-called ‘foreground process’ (the process having current input focus). At 60 it is determined whether a process running on the computer system conforms to a stored process profile. One or more process profiles may be stored locally in memory subsystem 30A of computer system 24, in memory subsystem 30B of input device 26, or on a remote server. In one embodiment, the process profile may be one in which the first form of user input is indicated (e.g., recommended or required) for every process fitting that profile. In another embodiment, the process profile may be one in which the second form of user input is not indicated (e.g., contraindicated or forbidden). Accordingly, a given process profile may include a listing of processes that are compatible with the first form of user input. In the alternative, a given process profile may include a listing of processes that are incompatible with the second form of user input. If it is determined, at 60, that the active process conforms to any process profile, then the method advances to 62, where the form of input in which to offer the position data is determined based on the profile. In one example, joystick input may be used if the process appears on a ‘white list’ for accepting joystick input, or on a ‘black list’ for accepting virtual-mouse input.

Continuing in FIG. 3, if it is determined that the process does not conform to any process profile, then the method advances to 64, where position data in the first form is offered to the process. In some multitasking environments, the position data may be offered to a plurality of processes concurrently running on the computer system, which may include application, service, and/or OS processes. In such environments, the position data (along with other forms of user input) may be offered for consumption by the various processes in a predetermined order—e.g., foreground process, background processes, OS. As such, the ‘process’ referred to hereinafter may correspond to any in a series of processes to be offered the position data and given the opportunity to provide feedback. It is then determined, at 66, whether the process encounters an error after the position data in the first form is offered. If the process does encounter an error in this scenario, then at 68 it is determined that offering the position data in the first form will cease and offering the position data in the second form will commence.

If the process does not encounter an error at 66, then method 56 advances to an optional step 70 and pauses for a predetermined timeout period while it is determined whether the position data offered in the first form has been consumed by the process. At 72, consumption feedback from the computer system is assessed in order to determine whether the position data in the first form was consumed by the process. Such consumption feedback may include a consumption confirmation from the process, which may result in removal of the input event from a queue of unconsumed input events. If it is determined that the position data in the first form was not consumed (within the timeout period, if applicable) then the method advances to 68, where offering the position data in the first form ceases, and where position data in the second form is offered instead. However, if it is determined that the position data in the first form has been consumed, then execution advances to 74 and to subsequent actions where the virtualization module assesses whether any user action indicates, in a heuristic sense, that rejection of the first form of user input is desired, and that the second form of user input should be offered instead.

At 74, for instance, additional hand movements of the user, transduced by the transduction componentry of the input device, are assessed to determine whether conditions warrant rejection of the first form of user input. In one particular example, pushing a certain button on the controller, moving the left joystick or direction pad, etc., may signal that the user wants to re-activate the game-controller aspects of the input device and reject virtual-mouse input. Under these or similar conditions, execution of the method advances to 68, where it is determined that offering the position data in the first form will cease and offering the position data in the second form will commence. Likewise, at 76 it is determined whether user touch is detected on a touchscreen of the computer system—e.g., touchscreen display 12. If user touch is detected, this may be taken as a signal that the user wants to dismiss the virtual mouse.

It goes without saying that method 56 may be executed repeatedly in a given user session to respond to changing conditions. For instance, the method may be used to determine, without explicit user action, that a process with input focus on the computer system is able to consume user input in a form that specifies absolute position, or unable to consume the data in a form that specifies relative position. In that event, position data is offered to the process in the form that specifies absolute position. Some time later, it may be determined, again without explicit user action, that the process with input focus on the computer system is able to consume user input in a form that specifies relative position, or unable to consume the data in a form that specifies absolute position. At this point, the position data may be offered to the process in the form that specifies relative position.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A system comprising:
transduction componentry of an input device of a computer system, the transduction componentry configured to transduce a hand movement of a user of the computer system into position data; and
a virtualization module of an operating system of the computer system, the virtualization module configured to determine automatically which form of user input to offer a process running on the computer system and to offer the position data to the process in the form determined.

2. The system of claim 1 wherein the virtualization module is configured to provisionally offer the position data to the process in the first form, and thereafter to assess feedback from the computer system that indicates whether the position data in the first form was consumed by the process, and to determine that offering the position data in the first form will cease and offering the position data in the second form will commence if the position data of the first form is not consumed by the process.

3. The system of claim 1 further comprising an internal data bus through which the position data is conveyed from the input device to the computer system.

4. The system of claim 1 further comprising one or more of a universal serial bus interface, a Bluetooth® transmitter, and an infrared transmitter, through which the position data is conveyed from the input device to the computer system.

5. The system of claim 1 wherein the computer system is a handheld game system.

6. Enacted on a computer system operatively coupled to a hand-actuated input device, a method to provide user input to a process running on the computer system, the method comprising:
determining automatically which form of user input to offer the process running on the computer system, the user input including position data from the input device; and
offering the position data to the process in the form determined.

7. The method of claim 6 wherein the process is an application, service, or operating-system process of the computer system.

8. The method of claim 6 wherein determining which form of user input to offer the process includes selecting a first form of user input and rejecting a second form of user input from a plurality of forms that the input device is capable of offering.

9. The method of claim 8 wherein the first form of user input is joystick input, and the second form of user input is virtual-mouse input.

10. The method of claim 8 wherein the first form of user input specifies an absolute position and the second form of user input specifies a relative position.

11. The method of claim 8 wherein determining which form of user input to offer the process includes determining whether the process conforms to a process profile in which the first form is indicated or the second form is contraindicated.

12. The method of claim 11 wherein the profile is characterized by a listing of processes compatible and/or incompatible with the first form of user input.

13. The method of claim 8 wherein determining which form of user input to offer includes, after offering the position data in the first form:
assessing feedback from the computer system that indicates whether the position data in the first form was consumed by the process; and
determining that offering the position data in the first form will cease and offering the position data in the second form will commence if the position data of the first form is not consumed by the process.

14. The method of claim 13 wherein the process is one of a series of processes offered the position data in the first form and providing feedback.

15. The method of claim 8 wherein determining which form of user input to offer includes determining that offering the position data in the first form will cease and offering the position data in the second form will commence, after a predetermined timeout period during which the position data in the first form is not consumed.

16. The method of claim 8 wherein determining which form of user input to offer includes determining that offering the position data in the first form will cease and offering the position data in the second form will commence if the process encounters an error after the position data in the first form is offered.

17. The method of claim 8 wherein the hand movement is a first hand movement, and wherein determining which form of user input to offer includes determining that offering the position data in the first form will cease and offering the position data in the second form will commence pursuant to transduction of a second hand movement by the input device.

18. The method of claim 8 wherein determining which form of user input to offer includes determining that offering the position data in the first form will cease and offering the position data in the second form will commence when user touch is detected on a touchscreen of the computer system.

19. Enacted in a computer system operatively coupled to a hand-actuated input device, a method to provide user input to the computer system, the method comprising:
determining without user action that a process with input focus on the computer system is able to consume user input in a form that specifies absolute position;
offering position data to the process in the form that specifies absolute position, the position data derived from a hand movement of a user of the computer system;
determining without user action that the process with input focus on the computer system is able to consume user input in a form that specifies relative position; and
offering the position data to the process in the form that specifies relative position.

20. The method of claim 19 wherein the form that specifies absolute position data uses a game-controller data structure, and the form that specifies relative position data uses a virtual mouse data structure.
